(19) United States
(12) Patent Application Publication
(10) Pub. No.: US 2024/0355147 A1
(43) Pub. Date: Oct. 24, 2024

(54) GESTURE DETECTION METHOD AND APPARATUS AND EXTENDED REALITY DEVICE

(71) Applicant: Beijing Zitiao Network Technology Co., Ltd., Beijing (CN)

(72) Inventors: Yuanjiang WANG, Beijing (CN); Zeming LI, Beijing (CN); Tao WU, Beijing (CN)

(21) Appl. No.: 18/642,014

(22) Filed: Apr. 22, 2024

(30) Foreign Application Priority Data
Apr. 23, 2023 (CN) 202310446054.X

(51) Int. Cl. G06V 40/20; G06F 3/01; G06T 17/00

(52) U.S. Cl. CPC G06V 40/28; G06F 3/017; G06T 17/00

(57) ABSTRACT

The embodiments of the present application disclose a gesture detection method and apparatus and an extended reality device. An embodiment of the method includes: acquiring a target image, wherein the target image is at least one of a plurality of images acquired by multi-view cameras of the extended reality device; obtaining a hand region prediction result; and determining a corresponding hand detection result based on the target image and the hand region prediction result.

### CROSS-REFERENCE TO RELATED APPLICATIONS

The present application is based on and claims priority of CN application Ser. No. 20/231,0446054.X, filed on Apr. 23, 2023, the disclosure of which is incorporated by reference herein in its entirety.

### TECHNICAL FIELD

Embodiments of the present disclosure relate to the field of computer technologies, and in particular to a gesture detection method and apparatus, and an extended reality device.

### BACKGROUND

With the continuous development of science and technology, human-computer interaction has become an important part in the people's life. The traditional human-computer interaction has its own limitations, and cannot meet requirements of people, so that a novel and convenient human-computer interaction mode needs to be developed. The hand is a part which is frequently used in a human body, and gestures have characteristics of simple expression mode, rich expression content, vividness and intuition, and naturally become a new direction of the human-computer interaction mode.

### SUMMARY

This disclosure is provided to introduce concepts in a simplified form that will be described in detail below in the following DETAILED DESCRIPTION. This disclosure is not intended to identify key features or essential features of the claimed technical solutions, nor is it intended to be used to limit the scope of the claimed technical solutions.

In a first aspect, an embodiment of the present disclosure provides a gesture detection method, applied to an extended reality device, comprising: acquiring a target image, wherein the target image is at least one of a plurality of images acquired by multi-view cameras of the extended reality device; obtaining a hand region prediction result; and determining a corresponding hand detection result based on the target image and the hand region prediction result.

In a second aspect, an embodiment of the present disclosure provides a gesture detection apparatus, disposed on an extended reality device, comprising: an acquisition unit configured to acquire a target image, wherein the target image is at least one of a plurality of images acquired by multi-view cameras of the extended reality device; an obtainment unit configured to obtain a hand region prediction result; and a determination unit configured to determine a corresponding hand detection result based on the target image and the hand region prediction result.

In a third aspect, an embodiment of the present disclosure provides an extended reality device, comprising: one or more processors; a storage means configured to store one or more programs which, when executed by the one or more processors, cause the one or more processors to implement the gesture detection method of the first aspect.

In a fourth aspect, an embodiment of the present disclosure provides a computer-readable medium having thereon stored a computer program, which when executed by a processor, performs the steps of the gesture detection method of the first aspect.

### BRIEF DESCRIPTION OF THE DRAWINGS

The above and other features, advantages, and aspects of the embodiments of the present disclosure will become more apparent by referring to the following DETAILED DESCRIPTION when taken in conjunction with the accompanying drawings. Throughout the drawings, the same or similar reference numbers refer to the same or similar elements. It should be understood that the drawings are schematic and that elements and components are not necessarily drawn to scale.

FIG. 1 is a flow diagram of one embodiment of a gesture detection method according to the present disclosure;

FIG. 2 is a schematic diagram of one application scenario of a gesture detection method according to the present disclosure;

FIG. 3 is a schematic block diagram of one embodiment of a gesture detection apparatus according to the present disclosure;

FIG. 4 is an exemplary system architecture diagram in which various embodiments of the present disclosure may be applied;

FIG. 5 is a schematic block diagram of a computer system adapted to implement an extended reality device of an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but rather are provided for a more complete and thorough understanding of the present disclosure. It should be understood that the drawings and the embodiments of the present disclosure are for illustration purposes only and are not intended to limit the scope of the present disclosure.

It should be understood that the various steps recited in method embodiments of the present disclosure may be performed in a different order, and/or performed in parallel. Moreover, the method embodiments may include additional steps and/or omit performing the illustrated steps. The scope of the present disclosure is not limited in this respect.

The term “including” and variations thereof as used herein are intended to be open-ended, i.e., “including but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the following description.

It should be noted that the terms “first”, “second”, and the like in the present disclosure are only used for distinguishing different devices, modules or units, and are not used for limiting the order or interdependence of the functions performed by the devices, modules or units.

It is noted that references to “a” or “plurality” in this disclosure are intended to be illustrative rather than limiting, and that those skilled in the art will appreciate that, it shall be understood as “one or more” unless the context clearly indicates otherwise.

The names of messages or information exchanged between devices in the embodiments of the present disclosure are for illustrative purposes only, and are not intended to limit the scope of the messages or information.

According to the gesture detection method and apparatus and the extended reality device, at least one of a plurality of images acquired by multi-view cameras of the extended reality device is taken as a target image; thereafter, a hand region prediction result is obtained; and thereafter, a corresponding hand detection result is determined based on the target image and the hand region prediction result. In this way, the hand region is intercepted from the current image using the predetermined hand region prediction result for detection, to obtain the hand detection result, thereby improving the hand detection speed.

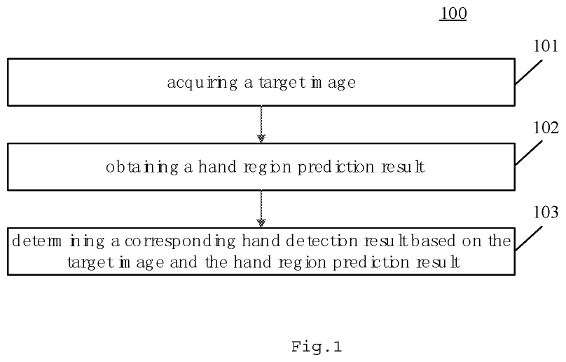

Reference is made to FIG. 1, which shows a flow 100 of one embodiment of a gesture detection method according to the present disclosure. The gesture detection method is generally applied to an Extended Reality (XR) device. XR describes a series of methods for changing reality, and since XR is a general term for multiple technologies such as VR (Virtual Reality), AR (Augmented Reality), and MR (Mixed Reality), the XR device generally includes: VR device, AR device and MR device. The gesture detection method comprises the following steps:

Step 101, acquiring a target image.

In the embodiment, an execution subject of the gesture detection method may capture a target image. The target image may be an image acquired by a camera at the current moment.

Here, the target image may be at least one of a plurality of images acquired by multi-view cameras of the extended reality device; for example, if a four-view camera is provided in the extended reality device, the target image may be one of the four acquired images, or may be a number of or all of the four acquired images.

Step 102, obtaining a hand region prediction result.

In the embodiment, the execution subject may obtain a hand region prediction result corresponding to the target image. Here, the hand region prediction result is usually predicted in advance, for predicting a position where a hand region in the target image may appear. The hand region prediction result may be a prediction box, and by intercepting the target image using the prediction box, it is very probable that a hand is present in the intercepted image region.

Step 103, determining a corresponding hand detection result based on the target image and the hand region prediction result.

In this embodiment, the execution subject may determine a corresponding hand detection result based on the target image acquired in the step 101 and the hand region prediction result obtained in the step 102.

Here, the execution subject may intercept a hand region image from the target image by using the hand region prediction result (usually, a prediction frame), and detect the intercepted hand region image to obtain a hand detection result. The execution subject can perform gesture recognition and gesture tracking on the intercepted hand region image, so as to detect the hand region.

Specifically, the gesture recognition mainly has three methods, namely template matching, neural network and hidden Markov model. The template matching method is mainly used for automatically extracting each frame of feature image according to geometric features of the gesture, namely edges of the gesture and features of a gesture region, and recognizing the gesture after matching it with a template library. The neural network is more often applied to static gesture recognition, and is characterized by strong anti-interference, self-organization, self-learning and strong anti-noise capability. Hidden Markov Model (HMM) is a statistical analysis model capable of describing temporal and spatial variations of a gesture signal in great detail.

Thereafter, the execution subject may track the hand using a Camshift (Continuous Adaptive Mean-Shift, motion tracking algorithm) algorithm. The Camshift algorithm converts an image into a color probability distribution map by using a color histogram model of the target, initializes a size and position of a search window, and adaptively adjusts the position and size of the search window according to a result obtained from a previous frame, thereby positioning a center position of the target in the current image.

Note that the gesture recognition and gesture tracking may be performed in the hand region by using existing gesture recognition algorithms and gesture tracking algorithms, which are not limited to the gesture recognition algorithms and the gesture tracking algorithms listed above.

In the method provided by the above embodiment of the present disclosure, at least one of a plurality of images acquired by multi-view cameras of an extended reality device is taken as a target image; thereafter, a hand region prediction result is obtained; and thereafter, a corresponding hand detection result is determined based on the target image and the hand region prediction result. In the existing gesture tracking algorithms, DCNN (Dynamic Convolution Neural Network) is used for sensing a position of a hand in an image, which has problems such as high power consumption, low speed. Compared with the related gesture tracking algorithms, the solution described in this embodiment directly intercepts the hand region from the current image by using the predetermined hand region prediction result for detection, so that the hand detection speed is increased, and the power consumption is reduced.

In some alternative implementations, the hand region prediction result may be determined based on a hand detection result sequence, which may be determined from a previous image of the target image. Here, each previous image of the target image corresponds to one hand detection result, and a plurality of hand detection results corresponding to a plurality of previous images constitute the hand detection result sequence. The number of the previous images may be a preset number, for example, 10, or may be all images prior to the target image.

As an example, the hand detection result sequence may be input into a hand region prediction model trained in advance, to obtain a hand region prediction result corresponding to the target image. The hand region prediction model can be used for characterizing a correspondence between a hand detection result sequence of a previous image of an image and a hand region prediction result corresponding to the image.

In this way, the hand region prediction result of the current image is determined using the hand detection result sequence of the previous image of the current image, so that the hand region prediction result corresponding to the current image can be obtained before the current image is acquired, the hand detection will not be delayed, and the hand detection speed is further improved.

In some alternative implementations, the hand detection result may be hand three-dimensional joint points corresponding to the previous image of the target image. The hand three-dimensional joint points can also be referred to as hand three-dimensional key points, and the number and position of the hand three-dimensional joint points mainly depend on a selected dataset; the existing datasets mainly comprise: a dataset of 14 joint points, a dataset of 19 joint points, and a dataset of 21 joint points. Here, the hand pose estimation may be made in the hand region in the previous image of the target image, to determine an azimuth of the hand, and then the hand three-dimensional joint points may be recovered from the hand region using the azimuth of the hand. The hand region prediction result may be determined based on the hand three-dimensional joint point sequence.

As an example, the execution subject may store a plurality of sets of hand three-dimensional joint point sequences, one of which represents a complete set of hand motion trajectories. For each of the plurality sets of hand three-dimensional joint point sequences, the execution subject may determine a matching degree between the hand three-dimensional joint point sequence and the set of hand three-dimensional joint point sequences. Thereafter, a hand three-dimensional joint point sequence with the highest matching degree is selected as a target hand three-dimensional joint point sequence. Then, a joint point subsequence matching the hand three-dimensional joint point sequence may be determined from the target hand three-dimensional joint point sequence, and a hand three-dimensional joint point adjacent to and subsequent to the joint point subsequence in the target hand three-dimensional joint point sequence may be predicted as a hand three-dimensional joint point corresponding to the target image. Finally, a projected region of the predicted hand three-dimensional joint point on a two-dimensional image can be determined as the hand region prediction result. For example, the hand three-dimensional joint point may be projected into the two-dimensional image using a projection camera model. The projection camera model is used to project a three-dimensional scene into the two-dimensional image.

As another example, the execution subject may input the hand three-dimensional joint point sequence into a joint point prediction model trained in advance, to obtain a hand three-dimensional joint point corresponding to the target image. The joint point prediction model can be used for characterizing a correspondence between the hand three-dimensional joint point sequence corresponding to a group of previous images of an image and the hand three-dimensional joint point corresponding to the image, so that the hand joint point corresponding to the current frame image can be predicted through the hand joint point sequences corresponding to previous multiple frame images. In this way, the accuracy of the hand three-dimensional joint point prediction can be improved.

The related gesture tracking algorithm for sensing a position of a hand in an image by using DCNN performs hand recognition on each target image independently, so that the recognition result of each target image is inconsistent. The solution predicts hand three-dimensional joint points of the current image using the hand three-dimensional joint point sequence of the previous image, and projects the hand three-dimensional joint points onto each image, ensuring consistence and association of the hand regions on multiple target images.

A threshold N for the number of frames in which the hand continuously appears is set, and the multi-view cameras of the extended reality device can take a first frame image in which the hand begins to appear as a first frame and continuously record the number of frames in which the hand appears. When the number of frames in which the hand appears continuously reaches N frames, the hand detection result determined from previous N frame images of the current frame image is started to be used to obtain a hand detection result sequence so as to predict a hand region prediction result of the current frame; when the number of frames in which the hand appears continuously exceeds N, the hand detection result determined from the previous N frames of the current frame image or more than N frame images can be used, to obtain a hand detection result sequence so as to predict the hand region prediction result of the current frame. N is a positive integer equal to or greater than one, and it is understood that the more the number of consecutive frames in which the hand is continuously detected, the more reliably the hand region prediction results in subsequent images can be determined, so the threshold N may be set greater than 1.

In some alternative implementations, the hand detection result sequence may include a hand detection result determined from an image after N frames, that is, after the hand is detected from the first frame, image frames in which the hand is detected in a number equal to or greater than N frames continuously appear, and when the hand region prediction result is determined based on the hand detection result sequence, the hand detection result determined from the image after N frames is included in the hand detection result sequence. At this time, the image after N frames is one of the plurality of images acquired by the multi-view cameras. The hand detection result sequence may also include a hand detection result determined from an image before N frames, where each frame of the image before N frames may include a plurality of images acquired by the multi-view cameras. Here, in order to ensure the accuracy of the hand region detection, for each frame of the image before N frames, generally, the acquired plurality of images, from multi-view, need to be used for hand detection, and meanwhile, in order to improve the speed of the hand region detection, for each frame of the image after N frames, one of the acquired plurality of images can be used for the hand detection.

Specifically, for the image before N frames, the execution subject may determine its hand detection result as follows: the execution subject may input the image (each frame includes a plurality of images from multi-view) before the N frames into a hand region recognition model trained in advance, to obtain a hand region in the image before N frames. The hand region recognition model can be used for characterizing the correspondence between the image and the hand region in the image. The hand region recognition model may be DCNN. Thereafter, the hand region may be detected.

For the image after N frames, the execution subject may determine the hand detection result as follows: the execution subject may obtain a hand region prediction result corresponding to the image (one image) after the N frames (the hand region prediction result being determined based on a hand detection result sequence of a previous image of the image), and then intercept a hand region from the image using the hand region prediction result for detection.

In this way, the accuracy of the hand region detection can be ensured, and the speed of the hand region detection can be increased.

It should be noted that, the multi-view cameras of the extended reality device may use the first frame image in which the hand begins to appear as the first frame, and if the hand does not appear in the fifth frame image, and it is detected in the sixth frame image that the hand reappears in the image, the sixth frame image is re-determined as the first frame.

It should be noted that, the specific value of N may be adjusted according to actual situations, and generally, the larger the value of N is, the better the gesture detection effect is.

In some optional implementations, the target image may be one of a plurality of images acquired by multi-view cameras of the extended reality device, that is, the target image may be an image after N frames. Specifically, after the multi-view cameras acquires a plurality of images, it can be detected whether a hand appears in the plurality of images; if a hand is present, it can be determined which frame of image the acquired plurality of images are; if the image is an image after N frames, one can be selected from the acquired plurality of images as a target image; if the image is an image before the N frames, the acquired plurality of images can be taken as the target images.

In this way, one can be selected from the acquired plurality of images for detection, and not all the acquired images are detected, so that the detection speed is increased.

In some alternative implementations, the camera from which the target image is sourced is different from the camera from which a previous image adjacent to the target image is sourced. As an example, if four cameras, namely, camera 1, camera 2, camera 3, and camera 4, are provided on the extended reality device, if a previous image adjacent to the target image is sourced from the camera 1, the target image acquired this time may be sourced from any one of the camera 2, the camera 3, and the camera 4. In this way, the image detected each time is different from the camera from which the image detected last time is sourced, so that the influence of the camera on the detection result is reduced, and the accuracy of the detection result is improved.

In some alternative implementations, the camera from which the target image is sourced may be determined based on a preset camera order. As an example, if four cameras are provided on the extended reality device, if the preset camera order is: camera 1, camera 2, camera 3 and camera 4, then an image acquired by the camera 1 is determined as the target image for the first time, an image acquired by the camera 2 is determined as the target image for the second time, an image acquired by the camera 3 is determined as the target image for the third time, an image acquired by the camera 4 is determined as the target image for the fourth time, and an image acquired by the camera 1 is again determined as the target image for the fifth time, and so on. In this way, the images acquired by each camera participate in image detection, which further reduces the influence of the cameras on the detection result, and improves the accuracy of the detection result.

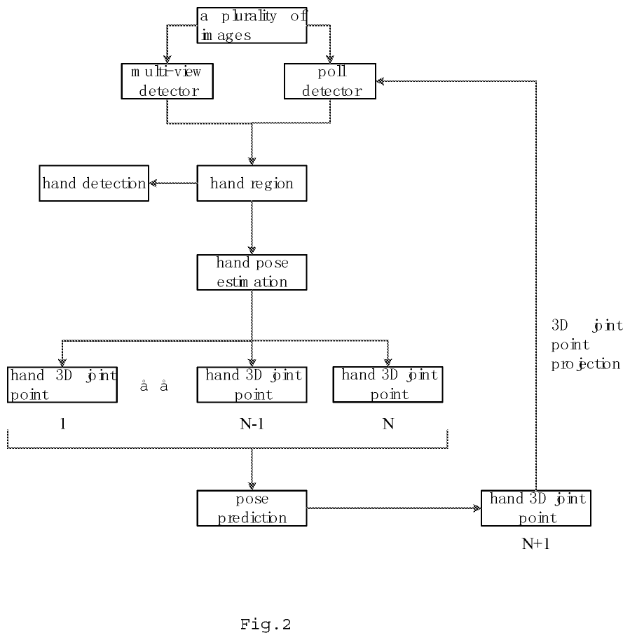

Reference is still made to FIG. 2, which is a schematic diagram of an application scenario of a gesture detection method according to the present embodiment. In the application scenario of FIG. 2, multi-view cameras of the extended reality device acquires a plurality of images, and for an image before N frames, an execution subject of the gesture detection method may use a multi-view detector to detect a hand region, that is, a hand region in the multi-view images is recognized through a hand region recognition model trained in advance. Thereafter, hand 3D joint points corresponding to the previous N frames of images are recovered through hand pose estimation. For an image after the N frames, taking a (N+1)th frame as an example, the execution subject of the gesture detection method may select one from the (N+1)th frame of images by using a polling detector, detect a hand region of the image, that is, perform pose prediction by using the hand 3D joint points corresponding to the previous N frames of images, predict the hand 3D joint point corresponding to the (N+1)th frame, project the hand 3D joint point onto the selected image to obtain the hand region, and then perform hand detection on the hand region.

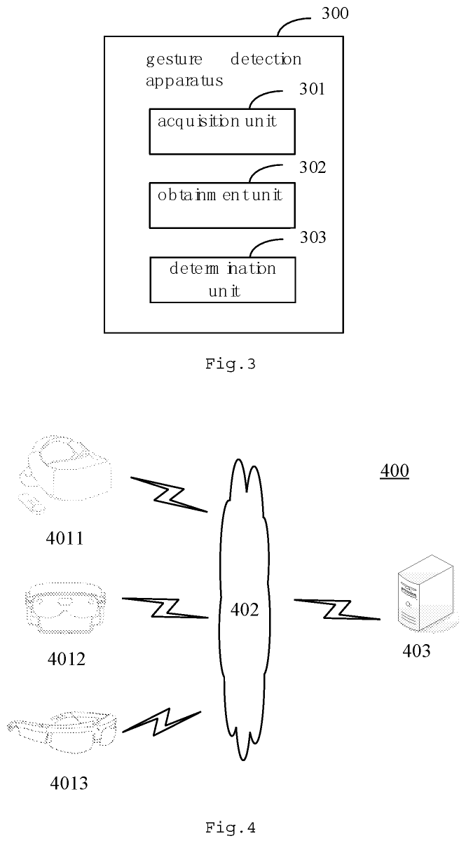

With further reference to FIG. 3, as an implementation of the methods shown in the above diagrams, the present application provides an embodiment of a gesture detection apparatus, where the apparatus embodiment corresponds to the method embodiment shown in FIG. 1, and the apparatus may be specifically applied to an extended reality device.

As shown in FIG. 3, the gesture detection apparatus 300 of the present embodiment includes: an acquisition unit 301, an obtainment unit 302 and a determination unit 303. The acquisition unit 301 is configured to acquire a target image, wherein the target image is at least one of a plurality of images acquired by multi-view cameras of the extended reality device; the obtainment unit 302 is configured to obtain a hand region prediction result; and the determining unit 303 is configured to determine a corresponding hand detection result based on the target image and the hand region prediction result.

In this embodiment, specific processing of the acquisition unit 301, the obtainment unit 302 and the determination unit 303 of the gesture detection apparatus 300 may refer to the step 101, the step 102 and the step 103 in the corresponding embodiment of FIG. 1.

In some alternative implementations, the hand region prediction result is determined based on a hand detection result sequence; the hand detection result sequence is determined based on a previous image of the target image.

In some optional implementations, the hand detection result is a hand three-dimensional joint point corresponding to the previous image of the target image; the hand region prediction result is determined based on the hand three-dimensional joint point sequence.

In some alternative implementations, the hand detection result sequence comprises a hand detection result determined from an image after N frames; the image after N frames is one of the plurality of images acquired by the multi-view cameras; and/or the hand detection result sequence comprises a hand detection result determined from an image before N frames; the image before N frames is the plurality of images acquired by the multi-view cameras.

In some optional implementations, the target image is one of the plurality of images acquired by the multi-purpose camera of the extended reality device.

In some alternative implementations, the camera from which the target image is sourced is different from a camera from which a previous image of the target image is sourced.

In some optional implementations, the camera from which the target image is sourced is determined based on a preset camera order.

FIG. 4 illustrates an exemplary system architecture 400 to which the embodiments of the gesture detection methods of the present disclosure may be applied.

As shown in FIG. 4, the system architecture 400 may include terminal devices 4011, 4012, 4013, a network 402, and a server 403. The network 402 serves as a medium for providing communication links between the terminal devices 4011, 4012, 4013 and the server 403. The network 402 may include various connection types, such as wired, wireless communication links, or fiber optic cables, among others.

The user may interact with the server 403 via the network 402 using the terminal devices 4011, 4012, 4013 to transmit or receive messages or the like, e.g., the terminal devices 4011, 4012, 4013 may send the acquired target image to the server 403. Various communication client applications such as video applications, game applications, instant messaging software, can be installed on the terminal devices 4011, 4012, and 4013.

The terminal devices 4011, 4012, 4013 can utilize multi-view cameras of the extended reality device to acquire the target image; thereafter, a hand region prediction result can be obtained; and thereafter, a corresponding hand detection result may be determined based on the target image and the hand region prediction result.

The terminal devices 4011, 4012, 4013 may be hardware or software. When the terminal devices 4011, 4012, 4013 are hardware, they may be various extended reality devices having a display screen and a camera and supporting information interaction, including but not limited to AR glasses, VR headset, etc. When the terminal devices 4011, 4012, and 4013 are software, they can be installed in the extended reality devices listed above. They can be implemented as multiple software or software modules (e.g., multiple software or software modules to provide a distributed service), or as a single software or software module. It is not particularly limited herein.

The server 403 may be a server that provides various services. For example, it may be a background server that provides a joint point prediction model and a hand region recognition model.

It should be noted that, the server 403 may be hardware or software. When the server 403 is hardware, it may be implemented as a distributed server cluster composed of multiple servers, or may be implemented as a single server. When the server 403 is software, it may be implemented as multiple software or software modules (e.g., to provide a distributed service), or as a single software or software module. It is not particularly limited herein.

It should be noted that, the gesture detection method provided in the embodiment of the present disclosure is generally executed by the terminal devices 4011, 4012, and 4013, and then the gesture detection apparatus is generally disposed in the terminal devices 4011, 4012, and 4013.

It should be understood that, the number of terminal devices, networks, and servers in FIG. 4 is merely illustrative. There may be any number of terminal devices, networks, and servers, as desired for an implementation.

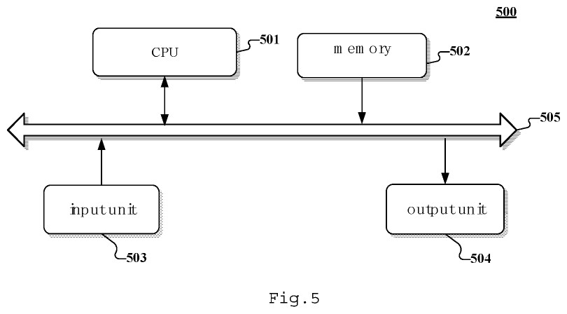

Reference now is made to FIG. 5, which shows a schematic block diagram of an extended reality device 500 adapted to implement the embodiments of the present disclosure. The extended reality device shown in FIG. 5 is only one example and should not bring any limitation to the function and use range of the embodiments of the present disclosure.

As shown in FIG. 5, the extended reality device 500 includes a Central Processing Unit (CPU) 501, a memory 502, an input unit 503, and an output unit 504, wherein the central processing unit 501, the memory 502, the input unit 503, and the output unit 504 are connected to each other through a bus 505. Here, the method according to the embodiment of the present disclosure may be implemented as a computer program and stored in the memory 502. The processing means 501 in the extended reality device 500 embodies the gesture detection function defined in the method of the embodiment of the present disclosure by calling the above-described computer program stored in the memory 502.

In some implementations, the input unit 503 may be a device such as a camera that can be used to acquire images, and the output unit 504 may be a device such as a display screen that can be used to display the acquired images. Thus, when the above-described computer program is called to execute the image display function, the processing means 501 can control the input unit 503 to acquire the images and control the output unit 504 to display the acquired images.

In particular, the processes described above with reference to the flow diagrams may be implemented as computer software programs, according to the embodiments of the present disclosure. For example, the embodiments of the present disclosure include a computer program product comprising a computer program embodied on a computer-readable medium, the computer program comprising program code for performing the method illustrated by the flow diagrams. It should be noted that the computer readable medium described in the embodiments of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the embodiments of the present disclosure, the computer readable storage medium may be any tangible medium that can contain, or store a program for use by or in connection with an instruction execution system, apparatus, or device. In the embodiments of the present disclosure, however, the computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. The computer readable signal medium may be any computer readable medium other than the computer readable storage medium and that can communicate, propagate, or transport a program for use by or in connection with an instruction execution system, apparatus, or device. Program code embodied on the computer readable medium may be transmitted using any appropriate medium, including but not limited to: electrical wires, optical cables, RF (radio frequency), etc., or any suitable combination of the foregoing.

The computer readable medium may be embodied in the extended reality device; or may exist separately without being assembled into the extended reality device. The computer readable medium carries one or more programs that, when executed by the extended reality device, cause the extended reality device to: acquire a target image, wherein the target image is at least one of a plurality of images acquired by multi-view cameras of the extended reality device; obtain a hand region prediction result; and determine a corresponding hand detection result based on the target image and the hand region prediction result.

Computer program code for carrying out operations of the embodiments of the present disclosure may be written in one or more programming languages or a combination thereof, including an object oriented programming language such as Java, Smalltalk, C++, and conventional procedural programming languages, such as “C” language or similar programming languages. The program code may execute entirely on the user's computer, partly on the user's computer, as a stand-alone software package, partly on the user's computer and partly on a remote computer or entirely on the remote computer or a server. In the latter scenario, the remote computer may be connected to the user's computer through any type of network, including a Local Area Network (LAN) or a Wide Area Network (WAN), or may be connected to an external computer (for example, through the Internet using an Internet service provider).

The flowchart and block diagrams in the drawings illustrate the architecture, functionality, and operation of possible implementations of the systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the drawings. For example, two blocks shown in succession may, in fact, be executed substantially concurrently, or may sometimes be executed in a reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or operations, or combinations of special purpose hardware and computer instructions.

According to one or more embodiments of the present disclosure, there is provided a gesture detection method, applied to an extended reality device, comprising: acquiring a target image, wherein the target image is at least one of a plurality of images acquired by multi-view cameras of the extended reality device; obtaining a hand region prediction result; and determining a corresponding hand detection result based on the target image and the hand region prediction result.

According to one or more embodiments of the present disclosure, the hand region prediction result is determined based on a hand detection result sequence; the hand detection result sequence is determined based on a previous image of the target image.

According to one or more embodiments of the present disclosure, the hand detection result is a hand three-dimensional joint point corresponding to the previous image of the target image; the hand region prediction result is determined based on the hand three-dimensional joint point sequence.

According to one or more embodiments of the present disclosure, the hand detection result sequence comprises a hand detection result determined from an image after N frames; the image after N frames is one of the plurality of images acquired by the multi-view cameras; and/or the hand detection result sequence comprises a hand detection result determined from an image before N frames; the images before N frames are the plurality of images acquired by the multi-view cameras.

According to one or more embodiments of the present disclosure, the target image is one of the plurality of images acquired by the multi-view cameras of the extended reality device.

According to one or more embodiments of the present disclosure, the camera from which the target image is sourced is different from a camera from which a previous image of the target image is sourced.

According to one or more embodiments of the present disclosure, the camera from which the target image is sourced is determined based on a preset camera order.

According to one or more embodiments of the present disclosure, there is provided a gesture detection apparatus, disposed in an extended reality device, comprising: an acquisition unit configured to acquire a target image, wherein the target image is at least one of a plurality of images acquired by multi-view cameras of the extended reality device; an obtainment unit configured to obtain a hand region prediction result; and a determination unit configured to determine a corresponding hand detection result based on the target image and the hand region prediction result.

According to one or more embodiments of the present disclosure, the hand region prediction result is determined based on a hand detection result sequence; the hand detection result sequence is determined based on a previous image of the target image.

According to one or more embodiments of the present disclosure, the hand detection result is a hand three-dimensional joint point corresponding to the previous image of the target image; the hand region prediction result is determined based on the hand three-dimensional joint point sequence.

According to one or more embodiments of the present disclosure, the hand detection result sequence comprises a hand detection result determined from an image after N frames; the image after N frames is one of the plurality of images acquired by the multi-view cameras; and/or the hand detection result sequence comprises a hand detection result determined from an image before N frames; the images before N frames is the plurality of images acquired by the multi-view cameras.

According to one or more embodiments of the present disclosure, the target image is one of the plurality of images acquired by the multi-view cameras of the extended reality device.

According to one or more embodiments of the present disclosure, the camera from which the target image is sourced is different from a camera from which a previous image of the target image is sourced.

According to one or more embodiments of the present disclosure, the camera from which the target image is sourced is determined based on a preset camera order.

The involved units described in the embodiments of the present disclosure may be implemented by software or hardware. The described units may also be provided in a processor, which may be described as: a processor comprising an acquisition unit, an obtainment unit and a determination unit. The names of these units do not in some cases constitute limitations on the units themselves, for example, the acquisition unit may also be described as a “unit configured to acquire a target image”.

The above only describes the preferred embodiments of the present disclosure and an explanation of the technical principles employed. It should be appreciated by those skilled in the art that the scope of the invention involved in the embodiments of the present disclosure is not limited to the technical solutions formed by specific combinations of the technical features described above, but also encompasses other technical solutions formed by arbitrary combinations of the above technical features or equivalent features thereof without departing from the above inventive concepts, for example, a technical solution formed by performing mutual replacement between the above features and technical features having similar functions to those disclosed (but not limited to) in the present disclosure.

What is claimed is:

1. A gesture detection method, applied to an extended reality device, comprising:
acquiring a target image, wherein the target image is at least one of a plurality of images acquired by multi-view cameras of the extended reality device;
obtaining a hand region prediction result; and
determining a corresponding hand detection result based on the target image and the hand region prediction result.

2. The method according to claim 1, wherein, the hand region prediction result is determined based on a hand detection result sequence; and
the hand detection result sequence is determined based on one or more previous images of the target image.

3. The method according to claim 2, wherein, the hand detection result is a hand three-dimensional joint point corresponding to the previous image of the target image;
the hand region prediction result is determined based on the hand three-dimensional joint point sequence.

4. The method according to claim 2, wherein, at least one of:
the hand detection result sequence comprises a hand detection result determined from an image after N frames;
the image after N frames is one of the plurality of images acquired by the multi-view cameras;
and
the hand detection result sequence comprises a hand detection result determined from an image before N frames;
the images before N frames is the plurality of images acquired by the multi-view cameras.

5. The method according to claim 1, wherein, the target image is one of the plurality of images acquired by the multi-view cameras of the extended reality device.

6. The method according to claim 5, wherein, the camera from which the target image is sourced is different from a camera from which a previous image of the target image is sourced.

7. The method according to claim 6, wherein, the camera from which the target image is sourced is determined based on a preset camera order.

8. An extended reality device, comprising:
one or more processors;
a storage means configured to store one or more programs which, when executed by the one or more processors, cause the one or more processors to implement a gesture detection method, the method comprising:
acquiring a target image, wherein the target image is at least one of a plurality of images acquired by multi-view cameras of the extended reality device;
obtaining a hand region prediction result; and
determining a corresponding hand detection result based on the target image and the hand region prediction result.

9. The device according to claim 8, wherein, the hand region prediction result is determined based on a hand detection result sequence; and
the hand detection result sequence is determined based on one or more previous images of the target image.

10. The device according to claim 9, wherein, the hand detection result is a hand three-dimensional joint point corresponding to the previous image of the target image;
the hand region prediction result is determined based on the hand three-dimensional joint point sequence.

11. The device according to claim 9, wherein, at least one of:
the hand detection result sequence comprises a hand detection result determined from an image after N frames;
the image after N frames is one of the plurality of images acquired by the multi-view cameras;
and
the hand detection result sequence comprises a hand detection result determined from an image before N frames;
the images before N frames is the plurality of images acquired by the multi-view cameras.

12. The device according to claim 8, wherein, the target image is one of the plurality of images acquired by the multi-view cameras of the extended reality device.

13. The device according to claim 12, wherein, the camera from which the target image is sourced is different from a camera from which a previous image of the target image is sourced.

14. The device according to claim 13, wherein, the camera from which the target image is sourced is determined based on a preset camera order.

15. A non-transitory computer-readable medium having thereon stored a computer program, which when executed by a processor, implements a gesture detection method, the method comprising:
acquiring a target image, wherein the target image is at least one of a plurality of images acquired by multi-view cameras of the extended reality device;
obtaining a hand region prediction result; and
determining a corresponding hand detection result based on the target image and the hand region prediction result.

16. The medium according to claim 15, wherein, the hand region prediction result is determined based on a hand detection result sequence; and
the hand detection result sequence is determined based on one or more previous images of the target image.

17. The medium according to claim 16, wherein, the hand detection result is a hand three-dimensional joint point corresponding to the previous image of the target image;
the hand region prediction result is determined based on the hand three-dimensional joint point sequence.

18. The medium according to claim 16, wherein, at least one of:
the hand detection result sequence comprises a hand detection result determined from an image after N frames;
the image after N frames is one of the plurality of images acquired by the multi-view cameras;
and
the hand detection result sequence comprises a hand detection result determined from an image before N frames;
the images before N frames is the plurality of images acquired by the multi-view cameras.

19. The medium according to claim 15, wherein, the target image is one of the plurality of images acquired by the multi-view cameras of the extended reality device.

20. The medium according to claim 19, wherein, the camera from which the target image is sourced is different from a camera from which a previous image of the target image is sourced.
